(19) United States
(12) Patent Application Publication
(10) Pub. No.: US 2024/0167641 A1
(43) Pub. Date: May 23, 2024

(54) LIGHT FIXTURE AND ASSOCIATED MANUFACTURING METHOD

(71) Applicant: FOHSE INC., LAS VEGAS, NV (US)

(72) Inventor: ALEX GERARD, ROGERS, MN (US)

(21) Appl. No.: 18/408,335

(22) Filed: Jan. 9, 2024

Related U.S. Application Data
(60) Provisional application No. 63/410,062, filed on Sep. 26, 2022.

(51) Int. Cl. F21K 9/61; F21K 9/69; F21K 9/90; F21V 29/76; F21V 31/04; F21V 23/00; F21Y 105/16; F21Y 115/10

(52) U.S. Cl. CPC F21K 9/61; F21K 9/69; F21K 9/90; F21V 29/763; F21V 31/04; F21V 23/005; F21V 2200/20; F21Y 2105/16; F21Y 2115/10

(57) ABSTRACT

A light fixture includes a base or heat sink, a printed circuit board connected to the heat sink, a number of LEDs electrically connected to the printed circuit board, a number of lenses located over the LEDs, and a transmission member or material disposed between the number of lenses and the LEDs, such as to eliminate an air gap between the lenses and the LEDs.

### RELATED APPLICATION DATA

The present application claims priority to U.S. Provisional Application Ser. No. 63/410,062, filed Sep. 26, 2022, and incorporates by reference said application as if set forth fully herein.

### FIELD OF THE INVENTION

The present invention relates to light fixtures and in particular, to light fixtures including light emitting diodes (LEDs). The present invention also relates to methods of manufacturing light fixtures.

### BACKGROUND OF THE INVENTION

Light fixtures now commonly utilize LEDs as the light emitting or generating elements. Lenses are commonly used in association with the LEDs. The lenses are located over the LEDs and function to focus the light output of the LEDs, such as to redirect the light emitted by each LED over a wider area. However, when the light fixtures employ lenses in this manner, the total amount of light transmitted out of the light fixture is undesirably limited due to absorption of light by the lenses. Further, the lenses undesirably trap heat which is generated by the LEDs. This heat degredates the LEDs and associated circuits, shortening the useful life thereof.

The present invention is directed to these and other issues associated with LEDs and LED light fixtures.

### SUMMARY OF THE INVENTION

Aspects of the invention comprise a light fixture and an associated manufacturing method. In one example, a light fixture includes a heat sink which supports a printed circuit board, a number of LEDs electrically connected to the printed circuit board, a number of lenses located over the LEDs, and a transmission member disposed between the number of lenses and the LEDs.

In another example, a method of manufacturing the aforementioned light fixture includes providing a heat sink, coupling a printed circuit board to the heat sink, electrically connecting a number of LEDs to the printed circuit board, locating lenses over the LEDs, and providing a transmission member between the lenses and the LEDs such that the transmission member contacts each of the LEDs and the lenses.

In an LED lens configuration according to the invention, a lens is located over an LED, and a transmission member or material is located between the LED and the lens.

In one configuration, the transmission member or material comprises silicone, such as a silicone liquid, gel or the like, such as where the transmission member comprises a molded silicone member or might comprise a silicone liquid which preferably occupies the space between the LED and its associated lens.

Further objects, features, and advantages of the present invention over the prior art will become apparent from the detailed description of the drawings that follows, when considered with the attached figures.

### DESCRIPTION OF THE DRAWINGS

FIG. 1 is a rear isometric view of a light fixture, in accordance with one non-limiting embodiment of the disclosed concept.

FIG. 2 is an exploded top isometric view of the light fixture according to FIG. 1.

FIG. 3 is another top exploded top isometric view of the light fixture according to FIG. 1.

FIG. 4 is an exploded side section view of the light fixture of FIG. 3.

FIG. 5 depicts the section view of the light fixture of FIG. 4 in an assembled state.

FIG. 6 is an enlarged view of a portion of the light fixture of FIG. 5.

FIG. 7 shows an isometric view of a heat sink for the light fixture of FIG. 6.

FIG. 8 is a side view of the heat sink of FIG. 7.

FIG. 9 is a flow chart corresponding to an example method of manufacturing a light fixture.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

As employed herein, the term “coupled” shall mean connected together either directly or through one or more intermediate parts or components.

As employed herein, the term “number” shall mean one or an integer greater than one (i.e., a plurality).

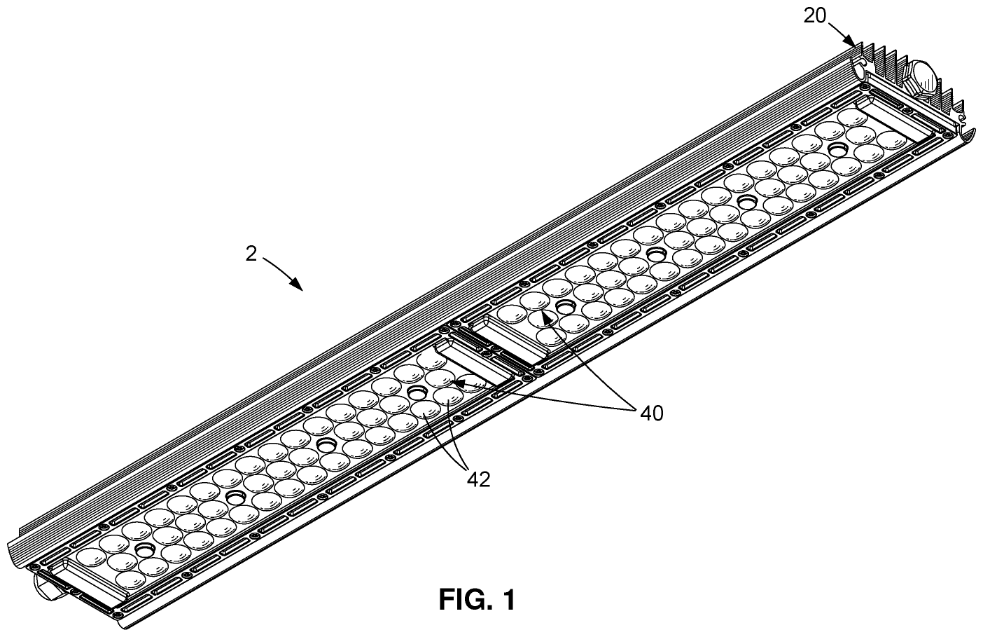

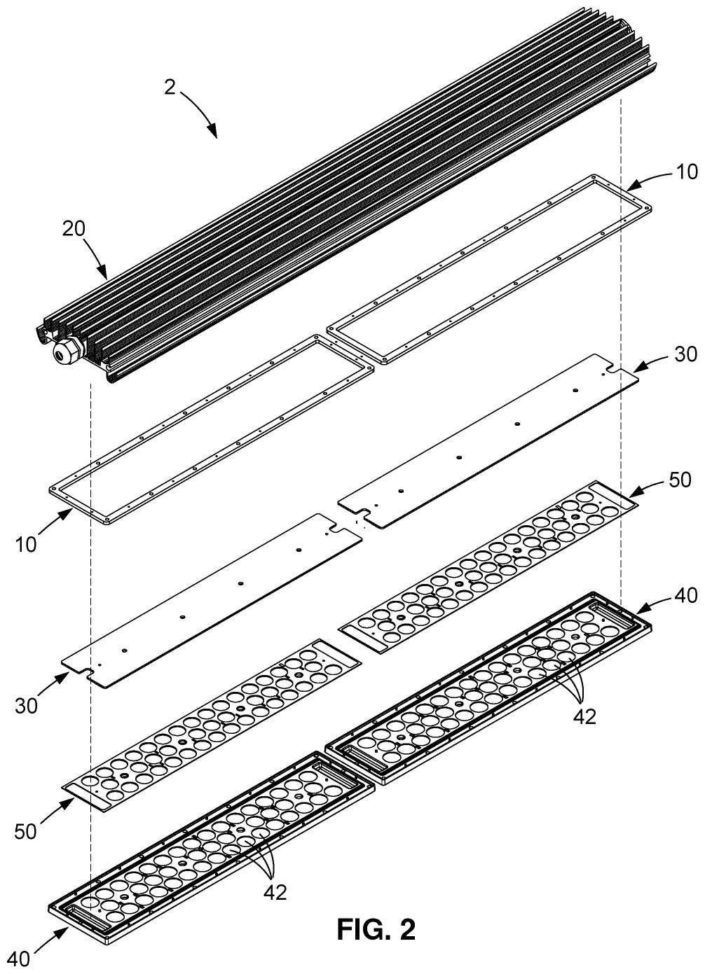

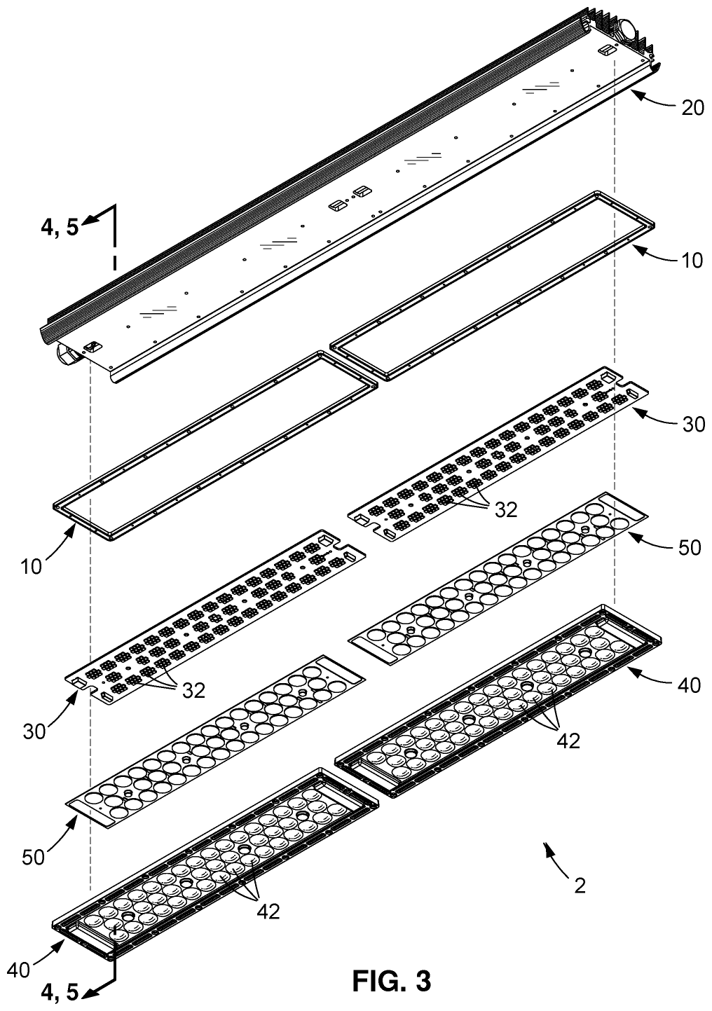

One embodiment of the invention is illustrated in FIG. 1, which shows an example light fixture 2, in accordance with one non-limiting embodiment of the disclosed concept. FIGS. 2-4 show exploded views of the light fixture 2. As shown in FIGS. 2-3, the example light fixture 2 includes a base element, such as having the form of, or including, a heat sink 20. As described below, the heat sink 20 may have a top or rear side, such as at which a plurality of fins or other heat dissipating elements are located, and an opposing bottom or front side.

The light fixture 2 also includes at least one printed circuit board 10 (when more than one is provided, they may be electrically connected to one another). The printed circuit board(s) (PCBs) 10 is preferably associated with a heat sink 20 and are located at the bottom or front side thereof.

The light fixture 2 further comprises one or more LEDs 32, and preferably a plurality of LEDs 32. In one embodiment, the LEDs 32 are associated with one more LED panels 30, each of which preferably has an array of LEDs 32 (FIG. 3), are preferably electrically connected to the printed circuit board 10. Further aspects of the LEDs 32 and their configuration are described below.

Preferably, one or more lenses 42 are located over the LEDs 32. In one embodiment, the lenses 42 are associated with or defined by one or more lens panels 40, each having a plurality of lenses 42. The lens panels 40 may be coupled to the printed circuit board(s) 10 and/or heat sink 20 in a position in which they extend over the LED panels 30.

In use, the LEDs 32 are configured to emit light, where the lenses 42 are each configured to redirect (such as disperse in one or more directions) the light output of the LEDs 32 in order to increase its intensity in a given area. The heat sink 20 is configured to dissipate heat given off by the LEDs 32.

The light fixture 2, in one example embodiment, is configured to be particularly useful for growing plants. For example, one or more of the LEDs 32 of the light fixture 2 may be configured to emanate light at a wavelength between at least 380 and 700 nanometers, which is conducive for photosynthesis, or may replicate “full spectrum” light (e.g. where the light fixture generally provides some energy in all visible wavelengths and has a correlated color temperature of at least 5,000K, and some UV emission). In the context of such a light fixture 2, the LEDs 32 may, in combination, generate full spectrum light (such as by individually emitting light of different wavelengths), or each LED might each be configured to emit such light. It is also contemplated that lights other than LEDs may be employed in an alternative light fixture (not shown), without departing from the scope of the disclosed concept. Additionally, it is contemplated that the LED panels 30 may include at least one array of LEDs, and/or may also include a fixture having as few as one LED. The LEDs may have various configurations, such as comprising a light-emitting diode that is covered by epoxy or located under a plastic or glass cover.

The LEDs 32 are preferably associated with the printed circuit boards 10, thus providing power and control to the LEDs 32. Of course, the LEDs 32 and printed circuit boards 10 might be formed as an integrated structure, or the LEDs 32 might be associated with/connected to the printed circuit boards 10.

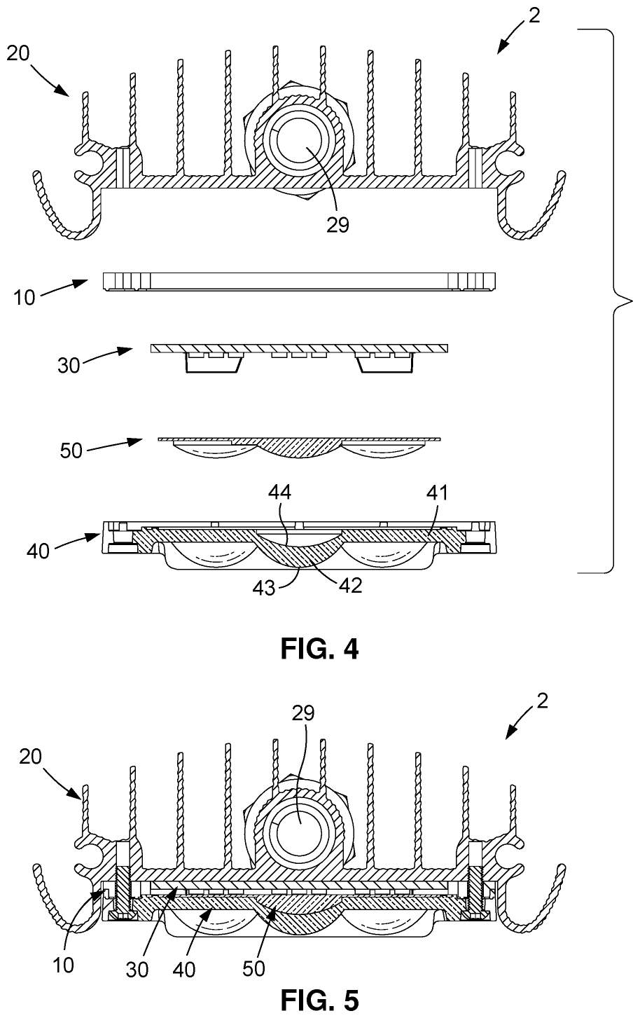

As indicated, the lenses 42 are preferably associated with the one or more LEDs 32. In one embodiment, a lens 42 is provided relative to each LED 32 or relative to a group of LEDs, such as two or more LEDs which are located proximate to one another. For example, as illustrated in FIG. 4, the LEDs 32 may be arranged in groups of two or more, where the LEDs in each group are spaced closer to one another than the groups of LEDs are spaced to one another. A lens 42 then extends over each group of LEDs 32.

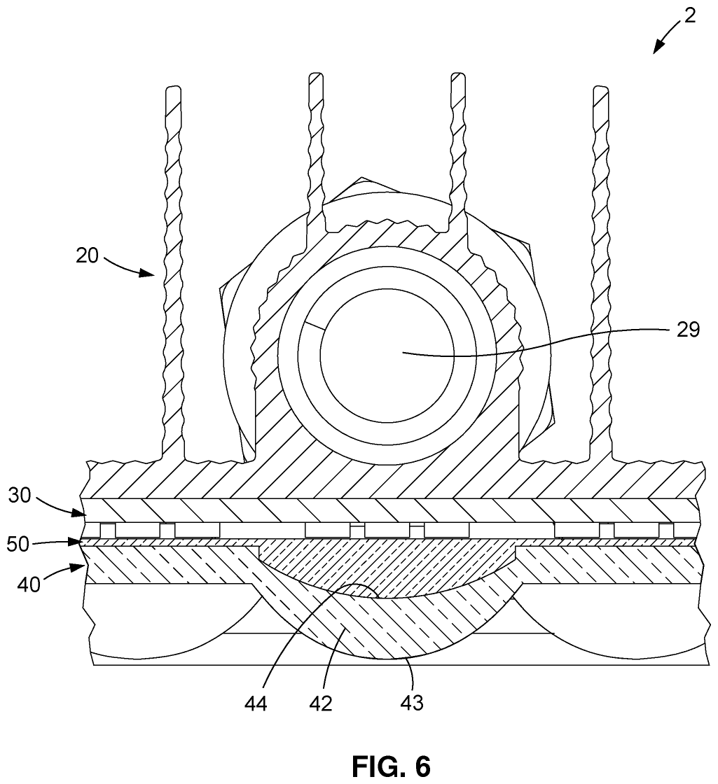

In the embodiment illustrated, a plurality of lenses 42 are defined by, or associated with, a lens panel 40. In some configurations, the lens panels 40 may comprise a generally planar base 41 with the plurality of lenses 42 formed therein, therewith, mounted thereto, or extending therefrom. In one embodiment, the base 41 and lenses 42 may be molded as a single body. In one embodiment, the lens panels 40 have a top or rear side (which faces the LEDs 32) and a generally opposing bottom or front side (which faces away from the LEDs). The lenses 42 preferably extend outwardly from the bottom of the lens panel 40, and are preferably convex at the bottom side 43 (FIG. 6) thereof and concave at the top or side 44 (FIG. 6) thereof.

The one or more lenses 42, or the lens panels 40, may be connected to the printed circuit board 10 or heat sink 20 or another supporting structure so as to be fixed in position relative to the LEDs 32.

In accordance with the disclosed concept, and as shown in FIGS. 2-6, the light fixture 2 further includes a transmission member or material 50 located between the one or more LEDs 32 and the one or more lenses 42. In one example embodiment, the transmission member or material 50 may be located between the LEDs 32 and the lenses 42 such that there is essentially no air gap between these components (e.g., the transmission member 50 contacts/engages each of the LEDs 32 and the lenses 42). See, in particular, FIGS. 5 and 6, which show a cross section of the transmission member 50 sealingly engaging a corresponding cross section of the lens panel 40 such that there is no air gap therebetween. As shown, the transmission member 50 is located on a rear side of the lens panel 40 such that at least one portion of the transmission member 50 sealingly engages a concavity of at least one of the corresponding lenses 42.

In general, the function of the transmission member or material 50 is to minimize and/or eliminate the air gap between each of the LEDs 32 and its associated lens 42. Doing this greatly improves photon transmission through the lenses 42 from the LEDs 32, and also acts to reduce the thermal resistance, as compared to prior art light fixtures that rely on air to fill the space between LEDs and lenses. Additionally, this leads to a cooler operating system that also runs more efficiently than prior art light fixtures. In particular, in existing light fixtures, emitted light travels through an epoxy or plastic/glass or other LED cover, then through air space between the LED and the lens, and then through the lens and beyond into the air around the light fixture. The air space between the LED and the lens acts as an insulating member, trapping heat proximate to the LED and the associated underlying circuit board. In addition, this configuration contributes to a high degree of light refraction and loss (particularly due to changes in speed of the light as is travels through the different mediums (plastic/air/plastic/air), which both reduces the output of the light and the efficiency of the light. On the other hand, in accordance with the present invention, the transmission member or material 50 significantly aids in heat dissipation and improved light transmission—both reducing refraction and increasing the light transmission and thus efficiency of the light. In one embodiment, the transmission member or material 50 reduces refraction of the light because there is less change in speed of the light as is moves from the LED through the transmission member or material 50 and then through the lens (because the density of transmission member or material 50 to the LED (and associated cover) and the lens, than is air).

In one example embodiment, the transmission member or material 50 comprises silicone. As employed herein, the term “silicone” shall mean a diverse class of fluids, gels, resins, or elastomers based on polymerized siloxanes, or substances whose molecules consist of chains of alternating silicon and oxygen atoms. It will, however, be appreciated that other suitable materials may be employed in a transmission member, without departing from the scope of the disclosed concept, provided the other materials perform the desired function of filling the space between the LEDs 32 (or other light source) and the lenses 42 while allowing light to be transmitted therethrough. For example, other liquids, gels or the like (e.g. materials other than gasses) such a water might be utilized (although these may be less effective that the materials noted above, while still being more effective than prior art configurations without a transmission member or material, where only air is located between the LED and lens).

In one embodiment, the transmitting member or material 50, such as the silicone, may comprise a gel and/or a resin, such as may be injected into the space between the lenses 42 and the LEDs 32. For example, one embodiment, the LED panels 40 may be secured over the LEDs 32 and then the transmitting member or material 50 may be introduced into the space between those members, such as by being injected into the space (such as through a port at one end of one of the lens panels 40 where a second port may be provided to allow air to escape, where those ports are then sealed after the injection process).

In another embodiment, the transmitting member or material 50 may be associated with a package which is located between the LEDs 32 and the associated lenses 42, such as a flexible bag or other body which is filled with the transmitting member or material 50.

In yet another embodiment, the transmitting member or material 50 might comprise a formed body, such as a molded silicone body which is placed between the LEDs 32 and the lenses 42, where the shape of the molded body is configured to fill the space(s) therebetween.

In yet another embodiment, the transmitting member or material 50 might be associated with individual ones of the lenses 42. For example, the concavity of each lens 42 might be filled with the transmission member or material 50, such as by filling that space with a liquid or gel silicone. The lens structure might then be located over the LEDs 32 and be pressed into position so that the LEDs 32 are pressed into engagement with the transmission member or material 50.

The heat sink 20 preferably provides structural support for the other components of the light fixture 2 (e.g. effectively comprising a base for the light fixture 2; of course, in other embodiments, the light fixture 2 might comprise a base element which supports the printed circuit boards 10 at one side, but having one or more heat sink elements mounted thereto, such as at an opposing side), but is also preferably configured to aid in heat dissipation (of the heat generated by the LEDs 32).

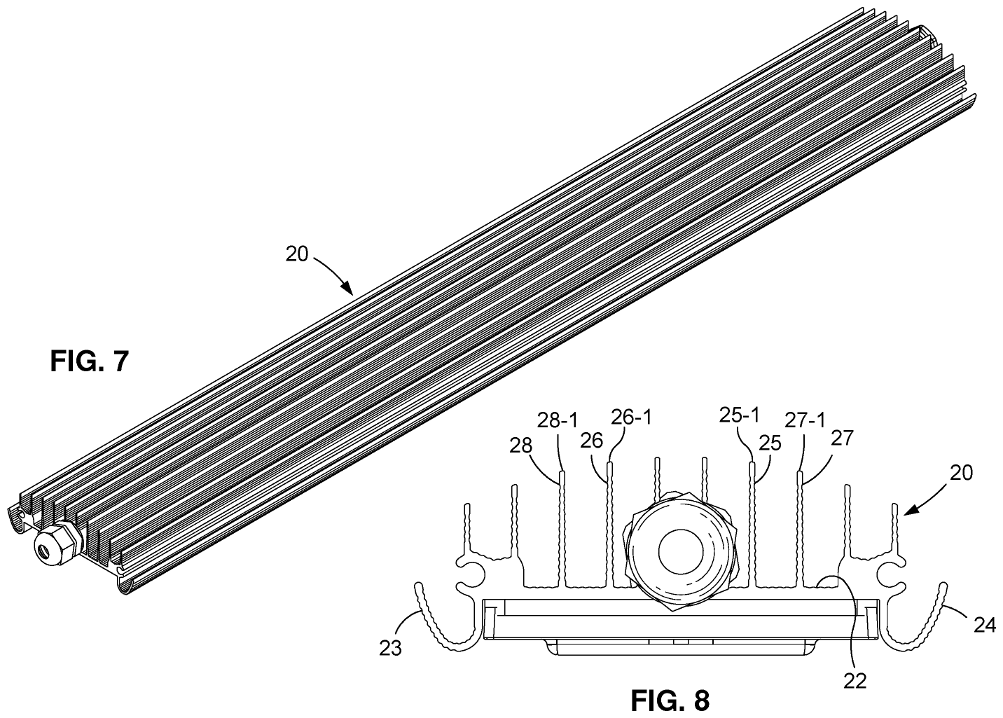

FIGS. 7 and 8 show isometric and side views, respectively, of one embodiment of the heat sink 20. As shown most clearly in FIG. 8, the heat sink 20 includes a base portion 22 and a plurality of heat dissipating elements or structures, such as fins 23, 24, 25, 26, 27 and 28 which extend outwardly from the base portion 22. In one example, the fins 23, 24, 25, 26, 27 and 28 each have a distal portion (distal portions 25-1, 26-1, 27-1, and 28-1 are indicated in FIG. 8) disposed opposite the base portion 22 and spaced a distance therefrom. As shown in FIG. 8, the distance that the fins 25, 26, 27, and 28 are spaced from the base portion 22 tapers from a center of the base portion 22 outwardly to opposing sides of the base portion 22. It will be appreciated that such a configuration advantageously allows heat from a center of the light fixture 2, which may be hotter, to dissipate in a streamlined manner.

Continuing to refer to FIG. 8, the fins 25, 26, 27, and 28 may be linear fins which are all located parallel to one another and perpendicular to the base portion 22, and each located between the first and second side fins 23 and 24. Additionally, in one example the first and second side fins 23 and 24 are each C-shaped and are each concave facing away from one another.

At least one portion of the heat sink 20 may define a mount, such as a slot or enclosed passage, for routing of a power cable or other wiring. For example, as illustrated, the base portion 22 may define an elongate passage 29 (best seen in FIG. 6), such as which extends longitudinally from end-to-end of the heat sink 20, such as through which a power cable or the like may be extended and placed into communication with the one or more printed circuit boards 10 for powering the LEDs 32. In one embodiment, as illustrated, connectors or other elements might be located at one or both ends of the base portion 22, such as to allow two or more light fixtures 2 to be connected to one another, such as in a linear array (where the passages 29 thereof may be aligned, thus allowing a single power cable to be routed through and to a plurality of the linked light fixtures 2).

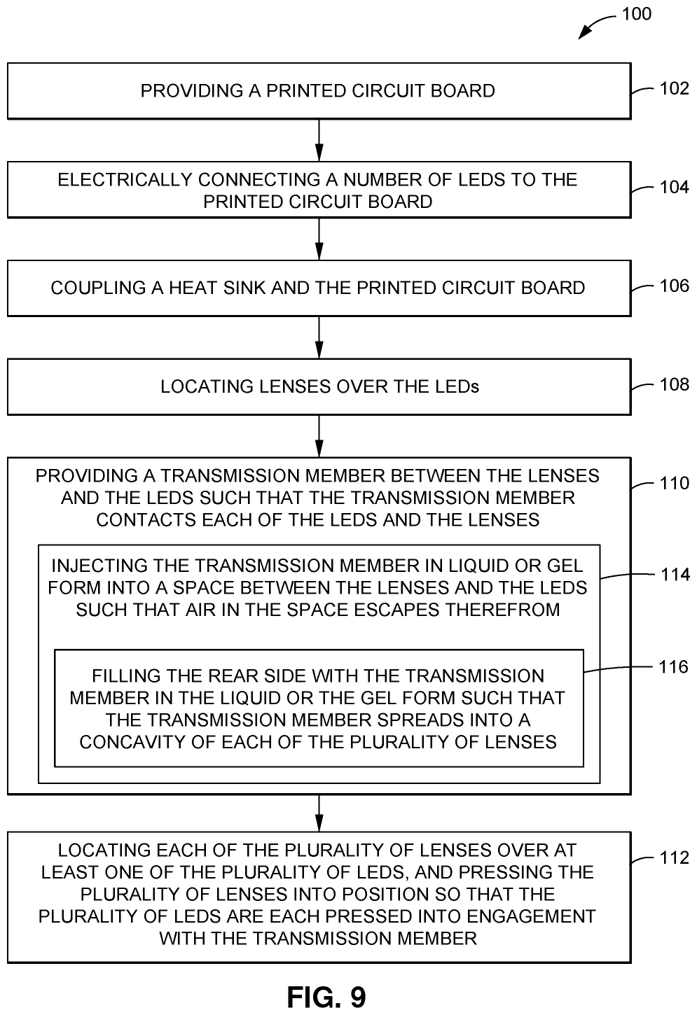

Referring to FIG. 9, a method 100 of manufacturing the aforementioned light fixture 2 includes a first step 102 of providing the printed circuit board 10, a second step 104 of electrically connecting the LEDs 32 to the printed circuit board 10, a third step 106 of coupling the heat sink 20 and the printed circuit board 10, a fourth step 108 of locating the lenses 42 (such as the lens panels 40) over the LEDs 32, such as by connection to the printed circuit board 10 and/or heat sink 20, and a fifth step 110 of providing the transmission member 50 between the lenses 42 and the LEDs 32 such that the transmission member 50 contacts each of the LEDs 32 and the lenses 42. The fifth step 110 may comprise a step 114 of injecting the transmission member 50 in liquid or gel form into a space between the lenses 42 and the LEDs 32 such that air in the space escapes therefrom and/or such that there is no air gap therebetween. Additionally, the step 114 may include a step 116 of filling the rear side of the lenses 42 with the transmission member 50 in the liquid or the gel form such that the transmission member 50 spreads into a concavity of each of the lenses 42. In another example, the method includes a sixth step 112, such as which occurs after the fifth step 110, wherein the lenses 42 (such as the lens panels 40) are located over a transmission member 50 which has been placed over the LEDs 32 (for example, where a molded silicone body may be placed between the LEDs 32 and the lenses 42/lens panels 40).

As illustrated, the light fixture 2 may be generally elongate, such as generally rectangular in shape, thus having two short ends and two long sides. However, the light fixture 2 might have other shapes and sizes, such as being square, circular or other shapes. In such configurations, a printed circuit boards 20 and associated lens panels 40 might be located not just end-to-end as illustrated in FIG. 2, but might be located side-by-side. In other configurations, a single printed circuit board 20 and/or single lens panel 40 might be used. For example, the light fixture 2 might be circular in shape, where the printed circuit board 20 and associated lens panel 40 is circular.

It will be understood that the abovementioned arrangements of apparatus are merely illustrative of applications of the principles of this invention and many other embodiments and modifications may be made without departing from the spirit and scope of the invention as defined in the claims.

What is claimed is:

1. A light fixture comprising:
a heat sink;
a printed circuit board supported by the heat sink;
a number of LEDs electrically connected to the printed circuit board;
a number of lenses located over said number of LEDs; and
a transmission member disposed between the number of lenses and the LEDs.

2. The light fixture according to claim 1, wherein the transmission member comprises silicone.

3. The light fixture according to claim 2, wherein the silicone comprises a gel and/or a resin, and wherein the gel and/or the resin is located in a body that fits between the number of LEDs and a bottom of the number of lenses.

4. The light fixture according to claim 1, wherein the transmission member is disposed between the lenses and the LEDs such that there is no air gap therebetween.

5. The light fixture according to claim 4, wherein the transmission member contacts each of the LEDs and the number of lenses.

6. The light fixture according to claim 1, wherein the number of LEDs comprises at least one array of LEDs.

7. The light fixture according to claim 1, wherein at least one of the number of LEDs is configured to emanate light at a wavelength between at least 380 and 700 nanometers.

8. The light fixture according to claim 1, wherein the number of lenses comprises a plurality of lenses which are convex at a front side thereof and concave at a rear side thereof, and wherein the transmission member is disposed in the rear side of each of the plurality of lenses in a concavity thereof.

9. The light fixture according to claim 1, wherein the heat sink comprises a base portion and a plurality of fins extending from the base portion, wherein the plurality of fins each have a distal portion disposed opposite the base portion and spaced a distance therefrom, and wherein the distance each of the plurality of fins are spaced from the base portion tapers from a center of the base portion outwardly to opposing sides of the base portion.

10. The light fixture according to claim 9, wherein the plurality of fins comprises a first side fin, a second side fin, and a plurality of linear fins disposed parallel to one another and each disposed between the first and second side fins, and wherein the first and second side fins are each C-shaped and are concave facing away from one another.

11. A method of manufacturing a light fixture, comprising:
providing a printed circuit board;
electrically connecting a number of LEDs to the printed circuit board;
coupling a heat sink and the printed circuit board;
locating a number of lenses over the LEDs; and
providing a transmission member between the lenses and the LEDs such that the transmission member contacts each of the LEDs and the lenses.

12. The method according to claim 11, wherein providing the transmission member comprises injecting the transmission member in liquid or gel form into a space between the lenses and the LEDs such that air in the space escapes therefrom.

13. The method according to claim 12, wherein the number of lenses comprises a plurality of lenses which are convex at a front side thereof and concave at a rear side thereof, and wherein injecting the transmission member comprises filling the rear side with the transmission member in the liquid or the gel form such that the transmission member spreads into a concavity of each of the plurality of lenses.

14. The method according to claim 13, wherein the LEDs are a plurality of LEDs, and wherein the method further comprises locating each of the plurality of lenses over at least one of the plurality of LEDs, and pressing the plurality of lenses into position so that the plurality of LEDs are each pressed into engagement with the transmission member.

15. The method according to claim 11, wherein the transmission member comprises silicone.

16. The method according to claim 15, wherein providing the transmission member between the lenses and the LEDs comprises injecting the transmission member between the lenses and the LEDs such that there is no air gap therebetween.

17. The method according to claim 16, wherein the LEDs comprises at least one array of LEDs.

18. The method according to claim 11, wherein at least one of the number of LEDs is configured to emanate light at a wavelength between at least 380 and 700 nanometers.

19. The method according to claim 11, wherein the heat sink comprises a base portion and a plurality of fins extending from the base portion, wherein the plurality of fins each have a distal portion disposed opposite the base portion and spaced a distance therefrom, and wherein the distance each of the plurality of fins are spaced from the base portion tapers from a center of the base portion outwardly to opposing sides of the base portion.

20. The method according to claim 19, wherein the plurality of fins comprises a first side fin, a second side fin, and a plurality of linear fins disposed parallel to one another and each disposed between the first and second side fins, and wherein the first and second side fins are each C-shaped and are concave facing away from one another.
